(19) United States
(12) Patent Application Publication
(10) Pub. No.: US 2012/0053978 A1
(43) Pub. Date: Mar. 1, 2012

(54) SELF-CONTAINED WEB-BASED COMMUNICATIONS PLATFORM FOR WORK ASSIGNMENTS

(76) Inventors: Glen Robert Andersen, San Antonio, TX (US); Christopher Rodney Low, Farmington, UT (US); Thorbergur Petur Sigurjonsson, Eagle Mountain, UT (US); Thomas K. Richins, Farmington, UT (US)

(21) Appl. No.: 13/179,036

(22) Filed: Jul. 8, 2011

Related U.S. Application Data
(60) Provisional application No. 61/368,633, filed on Jul. 28, 2010.

(51) Int. Cl. G06Q 10/06

(52) U.S. Cl. 705/7.14; 705/7.15

(57) ABSTRACT

The present invention extends to methods, systems, and computer program products for a self-contained web-based communications platform for work assignments. Embodiments of the invention provide a self-contained platform for creating, assigning, and completing work assignments, including recording and transmitting all relevant work-related materials between managers and staff electronically. For example, a computer system can create a work breakdown structure that breaks work projects into smaller work assignments and can store objects relevant to completion of a work assignment in a work assignments database. Using skills and availability information, the computer system can determine which staff has the skill and availability for completing the work assignment. The computer system assigns the work assignment to a selected staff member and makes the work assignments database available to the selected staff member. Other embodiments can include tracking work assignments in terms of work assignments completed correctly and providing for targeted and relevant marketing.

### CROSS-REFERENCE TO RELATED APPLICATIONS

This application claims priority to and the benefit of U.S. Provisional Application No. 61/368,633, filed Jul. 28, 2010, and entitled “METHODS AND SYSTEMS FOR WEB-BASED WORK TRANSFERS,” the disclosure of which is incorporated herein in its entirety.

### BACKGROUND

1. The Field of the Invention

This invention relates to systems, methods, and computer program products related to providing efficient work assignment and work communications between managers and staff.

2. The Relevant Technology

Business productivity software has been developed over the years to help improve the assignment and flow of work through organizations and to increase profitability and efficiency. Currently available project management software applications generally assist managers in organizing and running projects, but provide little or no assistance to the communications involved in actually assigning the work and making sure that it is performed correctly. Thus, in the current business environment, work assignments are generally communicated between managers and staff using a wide range of disparate techniques and tools including: 1) direct person-to-person contact between the manager and the staff; 2) shared servers for file exchange and collaboration, such as PROJECTWISE by BENTLEY, 3) File Transfer Protocol (FTP) servers; 4) Internet-based file transfer services such as www.sharefile.com, www.dropbox.com, www.box.net, etc.; 5) remote communication using e-mail, instant messaging, FAX, telephonic, and webinar services; 6) video or satellite conferencing services, as well as many other tools and techniques.

The actual mixture of tools and techniques used for work assignment-related communications in a particular organization can vary dramatically. As a result, each organization or group within the organization is left with the task of developing its own best practices in work assignment communications. It is often the case, therefore, that the work assignment and communications process has not been standardized within organizations, and that the work assignment and communications process varies dramatically within the organization (e.g., between different managers, offices, or groups). This often leads to significant loss of profit and lower efficiency when work is shared between groups or offices with the same organization. The loss of profit and lower efficiency is exacerbated when different organizations join together on a project. As a general rule, therefore, greater efficiency and productivity is often achieved by collocating managers and staff so that better communication is facilitated (e.g., greater in-person contact). Collocating managers and staff can itself add to the cost of doing business and often leads to significant inconvenience for those involved.

Furthermore, currently available project management software applications generally measure staff performance by comparing the actual number of hours used to perform a particular task to an estimated number of hours need to complete the task. Managing staff through estimated hours creates an entire class of management challenges related to ensuring productivity, efficiency, and motivation of the staff, and related to ensuring the proper utilization of limited resources. As a result, measuring staff performance based on hours worked also adds to the costs of doing business.

### BRIEF SUMMARY

The present invention extends to methods, systems, and computer program products for a self-contained web-based two way communications platforms for communication of work assignments between managers and staff

In one embodiment, a method for managing work assignments through a self-contained web-based communications platform can include a computer system creating a work breakdown structure that breaks work projects into work assignments arranged into hierarchical levels, as well as creating a work assignments database that stores objects relevant to completion of the work assignments. The computer system also assigns skill sets to a work assignment, which capture skills relevant to completing the work assignment, and which permit the matching the work assignment with staff having the relevant skills. Using an experiential matrix that maps staff with performance ratings, and an availability matrix that contains temporal information about staff availability, the computer system assigns the work assignment to an available staff member. The computer system also provides the staff member access to the work assignments database and the objects.

In another embodiment, a computer-implemented method for managing work assignments that are evaluated based on work assignments being completed correctly and on estimated hours for completion of the work assignments can include a computer system assigning a work assignment 1) a lump-sum amount that is credited when the work assignment is completed correctly, 2) an estimated hours for completion of the work assignment, and 3) a statement of work that defines how the work assignment is completed correctly. The work assignment is assigned by the computer system to a staff member. Subsequently, notification of completion of the work assignment is received at the computer system from the staff member, along with a number of hours spent by the staff member completing the assignment. The computer system, in turn, notifies a manager that the work assignment has been completed. Upon receiving verification from the manager that the work assignment was completed correctly (after a thorough review), the computer system initiates credit for payment of the lump-sum amount to the particular staff member. The computer system also records the number of hours spent by the staff member to complete the work assignment.

In yet another embodiment, a method for managing work assignments through a self-contained web-based communications platform can include a computer system breaking down a project into logical divisions from which work assignments are organized and referenced. The computer system also transmits input files and output files between a manager making a work assignment and a staff member performing the work assignment. The computer system associates a lump sum amount to the work assignment, which is paid to the staff member when the work assignment is completed correctly (as determined by the manager). The computer system tracks estimated and actual hours worked by the staff member in completing the work assignment.

This Summary is not intended to identify key features or essential features of the claimed subject matter, nor is it intended to be used as an aid in determining the scope of the claimed subject matter.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a computer architecture that supports a self-contained web-based communications platform for work assignments;

FIG. 2A illustrates an administrative user interface for forming a work breakdown structure;

FIG. 2B illustrates a summary tab of a work assignment user interface for forming work assignments;

FIG. 2C illustrates a skills selection dialogue for associating skills with work assignments;

FIG. 2D illustrates a staff selection dialogue for associating staff with work assignments;

FIG. 2E illustrates an input documents tab of a work assignment user interface for forming work assignments;

FIG. 2F illustrates an output documents tab of a work assignment user interface for forming work assignments;

FIG. 2G illustrates a contracts tab of a work assignment user interface for forming work assignments;

FIG. 2H illustrates an instruction/communication tab of a work assignment user interface for forming work assignments;

FIG. 2I illustrates an integrated video player device in a web-based communications platform;

FIG. 3 illustrates an integrated screen video capture utility in a web-based communications platform;

FIG. 4 illustrates a flow diagram of an experiential matrix used as part of a web-based communications platform for staff assignments;

FIG. 5 illustrates a flow diagram of an availability matrix used as part of a web-based communications platform for staff assignments;

FIG. 6 illustrates a flow chart of an example method for managing work assignments through a self-contained web-based communications platform;

FIG. 7 illustrates a flow chart of an example method for managing work assignments that are evaluated based on work assignments being completed correctly and on estimated hours for completion of the work assignments; and

FIG. 8 illustrates a flow chart of an example method for managing work assignments through a self-contained web-based communications platform.

### DETAILED DESCRIPTION

The present invention extends to methods, systems, and computer program products for self-contained two-way communications platforms for communication of work assignments between managers and staff.

The embodiments disclosed herein include a web-based communications platform (Internet and/or intranet) through which organizations can assign and coordinate work between managers and staff. These work assignments can be made between local individuals, remote individuals, and/or individuals in different organizations with equal efficiency and profitability.

In one or more embodiments, the self-contained communications platform can manage substantially all communications involved with communicating work assignments between managers and staff via a single web-based application. The communications platform can provide functionality for managers to make assignments, for staff to perform the work and submit their work product, for manager review of completed work projects and staff performance, and even for instruction/training The disclosed communications platform can therefore provide a central and consistent work communications platform that can greatly increase the efficiency of work assignments and communications between managers and staff, and that can substantially lower the cost and risk of doing business.

Embodiments of the communications platforms disclosed herein enable managers to provide, in electronic format, all information, training, assignment-specific instructions, and resource materials necessary or relevant for sub-managers and staff to perform a particular assignment. Similarly, sub-managers and staff are able to return, in electronic format, the results of their work assignments for review and acceptance. The work transfer system disclosed herein also enables the standardization of the work assignment process and the sharing of work assignments between groups within the same organization and between groups within different organizations. For example, work assignments can be assigned to local groups, remote groups, and groups outside of the organization.

One or more embodiments also provide a communications platform that manages work assignments both in terms of estimated hours needed to complete a work assignment, and also in terms of “work assignments completed correctly” on a lump sum basis. Managing by work assignments completed correctly on a lump sum basis, instead of by actual hours worked, places the burden of productivity, efficiency, motivation, and proper utilization of resources on staff members (encouraging them to “own” the work assignment), and helps focus managers on ensuring that work is completed correctly instead of concentrating on hours spent by staff.

One or more embodiments also provide a precise context-sensitive marketing environment that enables the insertion of targeted marketing links at relevant points in the workflow (e.g., at the time that a work assignment is given and the staff has the need for productivity tools, background review information, or other tools) so that the staff can acquire relevant tools and/or background review information in real time in the same web-based environment from which the assignment is given. Using work assignment codes that represent the general nature of the work assigned, potential marketers are able to prepare beforehand their marketing approach for specific types of work assignments. Thus, the communications platform creates a rich platform for context-sensitive high-precision marketing for developers of business productivity software and for purveyors of reference information used for business, such as technical journals, technical books, etc.

One or more embodiments also provide a library for assignment-specific instructional and review materials. When creating a work assignment, a manager can assign relevant training materials to the work assignment through the communications platform, which then makes these materials available to any assigned staff. The assigned staff can then review/complete the training materials in addition to completing the work assignment itself. When the assigned staff indicates that the work assignment is completed, the communications platform can provide the manager the identity of any training materials the staff completed. The review and acceptance of the work assignment by a qualified manager may constitute continuing education or professional development hours for the staff completing associated training materials. The communications platform can also provide for the issuance of a certificate that can provide documentation of continuing education or professional development.

### Computing Environment

Initially, embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are recordable type storage media or other physical computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) include RAM, ROM, EEPROM, CD-ROM, DVD-ROM or other optical disk storage, magnetic disk storage or other magnetic storage devices, or any other medium which can be used to store desired program code means in the form of computer-executable instructions or data structures and which can be accessed by a general purpose or special purpose computer and which are recorded on one or more recordable type medium (device).

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop/notebook computers, message processors, hand-held devices, multi-processor systems, microprocessor-based or programmable consumer electronics, network PCs, minicomputers, mainframe computers, tablets, mobile smartphones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

### Communications Platform

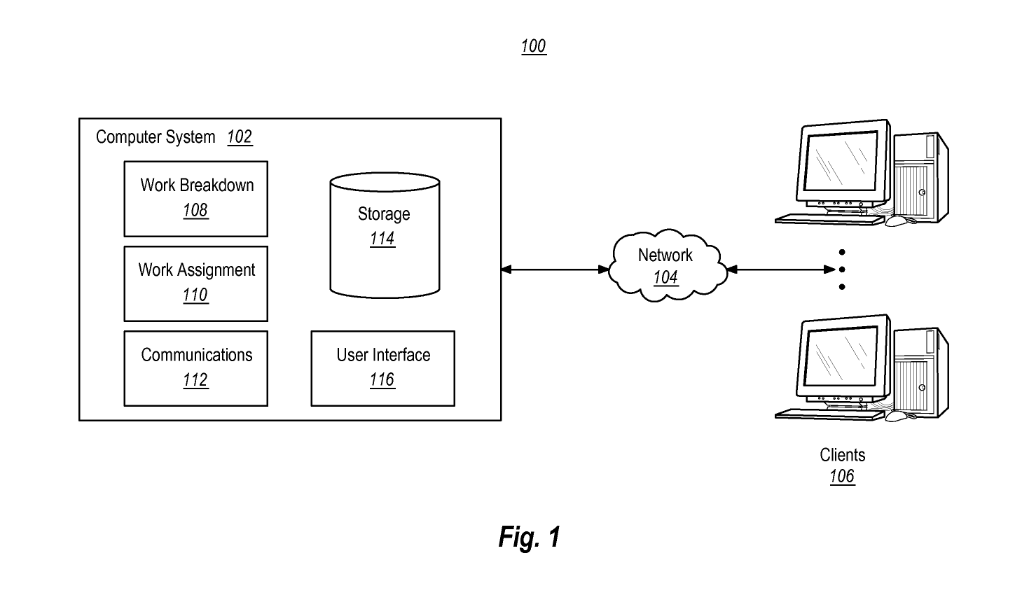

FIG. 1 illustrates an example computer architecture 100 that supports a self-contained web-based communications platform for work assignments (e.g., for communications between managers and staff as they relate to assigning and completing work assignments). Referring to FIG. 1, computer architecture 100 includes a computer system 102 and one or more clients 106. Each of the depicted computer systems or components is connected to one another over (or is part of) a network 104, such as, for example, a Local Area Network (“LAN”), a Wide Area Network (“WAN”), and even the Internet. Accordingly, each of the depicted computer systems or components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network 104.

Computer system 102 is configured to provide a web-based communications platform for work assignments. In some embodiments, computer system 102 comprises a distributed computing system that includes a plurality of physical or virtual machines. Computer system 102 can provide the web-based communications platform as a server computer system in communication with one or more client computer systems 106 over network 104. Computer system 102 can include a plurality of components for providing the web-based communications platform. As shown, for example, the computer system 102 can include a work breakdown component 108, a work assignment component 110, a communications component 112, a storage component 114, and a user interface component 116. While the components illustrated are provided for ease in description, it will be appreciated that the computer system 102 can include a variety of components in a wide array of configurations for providing the web-based communications platform. Accordingly, the invention is not limited by the components shown.

Work breakdown component 108 is configured to break a work project into constituent work assignments as part of a work breakdown structure. The work breakdown component 108, which can potentially operate with the assistance of user input from one or more managers at the clients computing systems 106, can break a work project into a potentially unlimited number of hierarchical levels, with each level corresponding to one or more work assignments. Breaking a work project into constituent work assignments facilitates assigning the portions of the work project to various staff (i.e., for completion of individual work assignments) or to sub-managers (i.e., for further breakdown using work breakdown component 108). The manager(s) typically determine the number of levels in the work breakdown structure and the amount of detail with which a particular set of work assignments is developed, depending on the nature of the project and the capabilities of the staff receiving the work assignments. Using work breakdown component 108, each work assignment can be broken into tasks of limited and well-defined scope, which can be assigned to staff and managed using work assignment component 110. Each work breakdown component and work assignment can be assigned with a unique identification code (e.g., an alpha-numeric identifier), as discussed in more detail later.

Work assignment component 110 is configured to manage the assignment of work assignments (as constructed by work breakdown component 108) to staff, and to facilitate review of completed work assignments. Work assignment component 110 enables work assignments, and any relevant documents, to be centrally managed and electronically delivered, versioned, and archived. Thus, work assignment component 110 can be configured to access or create a work assignments database (e.g., using storage component 114) that stores work assignment related documents, including one or more of input data, output data, contracts, or instructional materials for each work assignment. Thus, using work assignment component 110, a manager can make a work assignment available to a staff member, along with all materials relevant to completing the work assignment. Work assignment component 110 can also facilitate the selection of staff having the requisite skills and availability for completing the work assignment. For example, work assignment component 110 can be configured to access/manage an experiential matrix that maps staff with performance ratings and skill sets, and an availability matrix that contains temporal information about staff availability, to choose staff optimally suited for completion of a particular work assignment (the experiential and availability matrices can be stored at storage component 114, for example). Work assignment component 110 is also configured to facilitate review of completed work assignments, update of the experiential and availability matrices, and management of work assignments in terms of work assignments completed correctly, on a lump sum basis.

Communications component 112 is configured to facilitate communications between computer system 102 and clients 106, and can be used in connection with work breakdown component 108 and work assignment component 110. For example, communications component 112 can be used for receiving manager input defining a work breakdown structure, for receiving manager input making work assignments, for receiving staff input retrieving and completing work assignments, for transferring any relevant files and data, etc.

Storage component 114 is configured to store data for use by the communications platform, and can comprise any number of interconnected or separate storage components. Storage component 114 can store work breakdown structures, assignments databases, experiential and availability matrices, and the like. Storage component 114 can also store any other relevant information, such as contact information for project managers, staff and clients, login credentials, information related to auditors and investors, etc.

User interface component 116 is configured to generate one or more user interfaces that enable user interactivity with the communications platform. In one embodiment, user interface component 116 generates one or more web-based user interfaces using a combination of web technologies, such as one or more of HTML, XML, PHP, SOAP, AJAX, JAVA/JAVASCRIPT, FLASH, .NET, RUBY ON RAILS, etc.

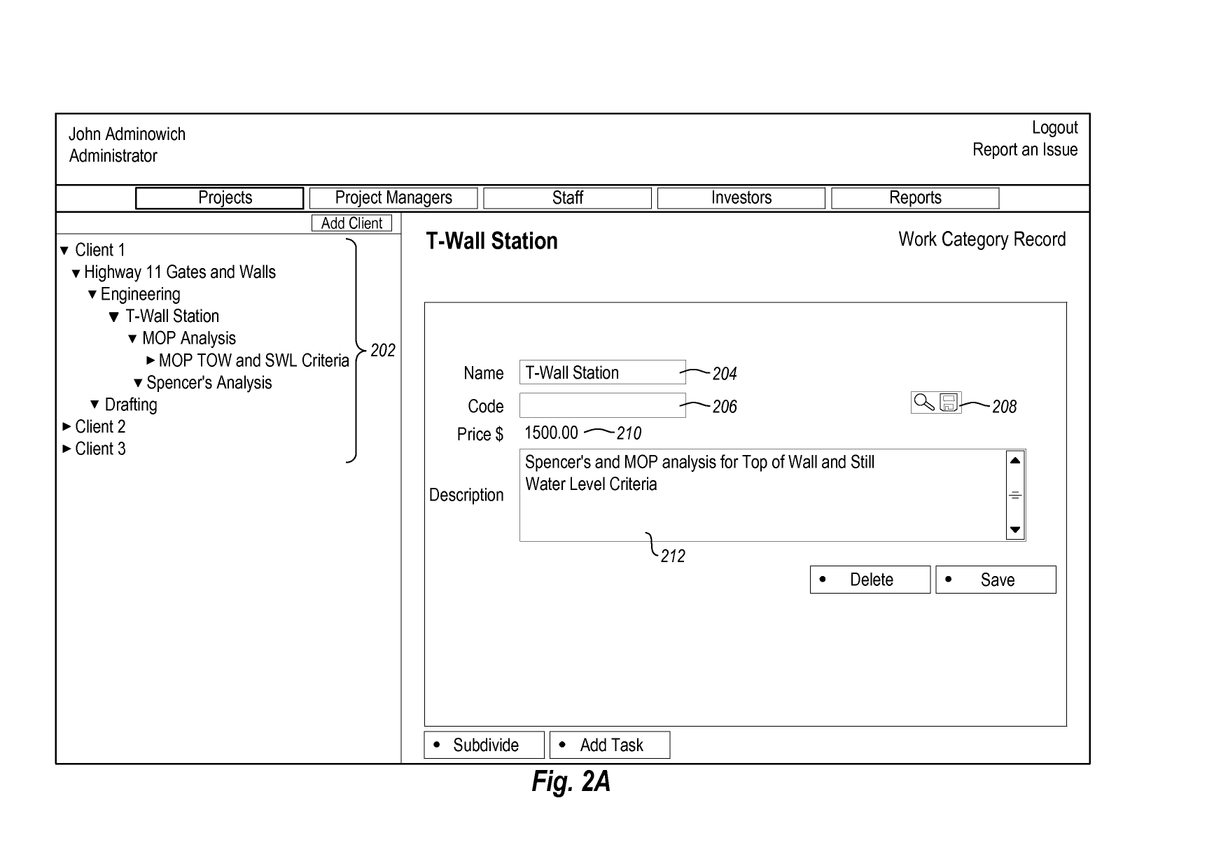

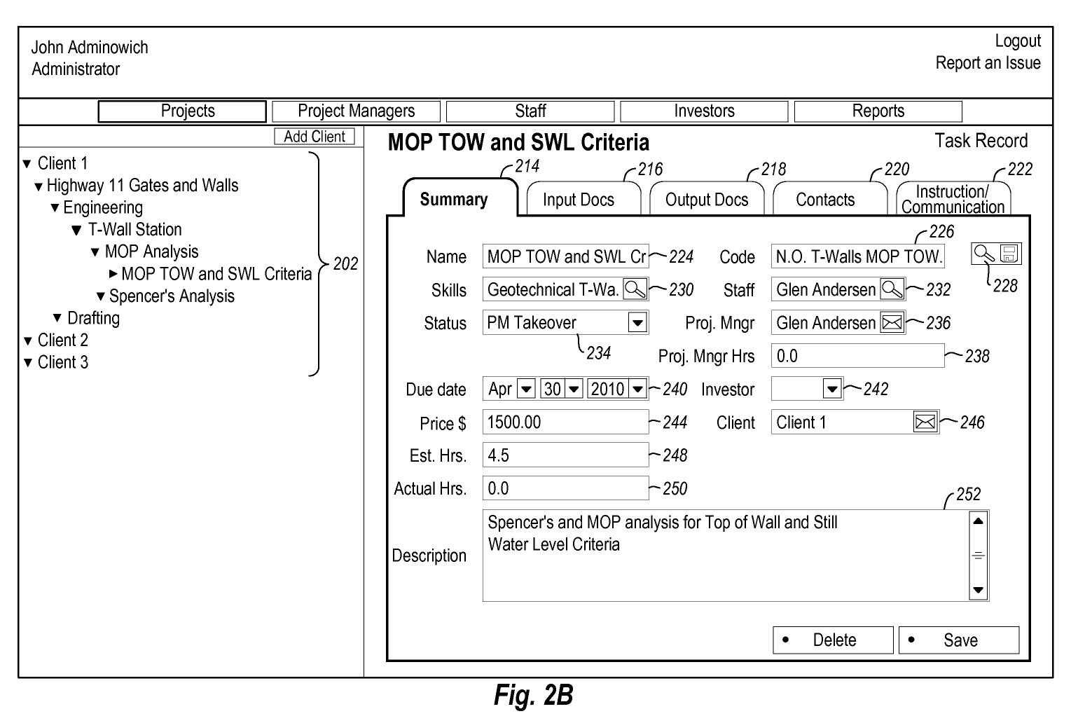

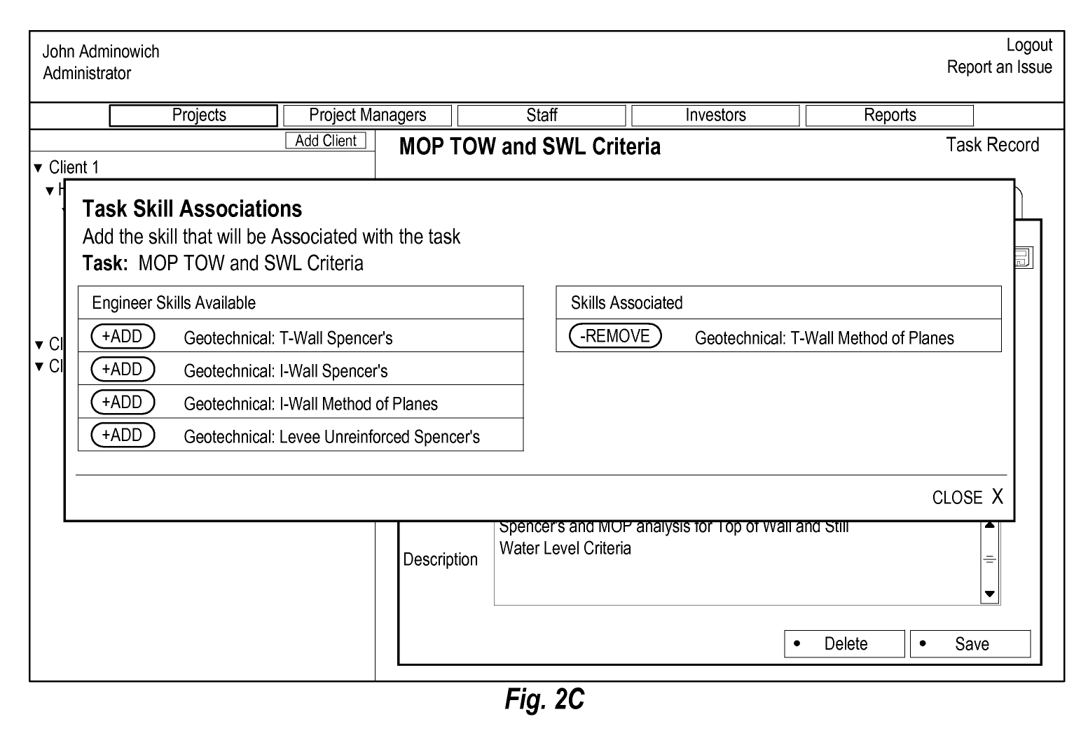

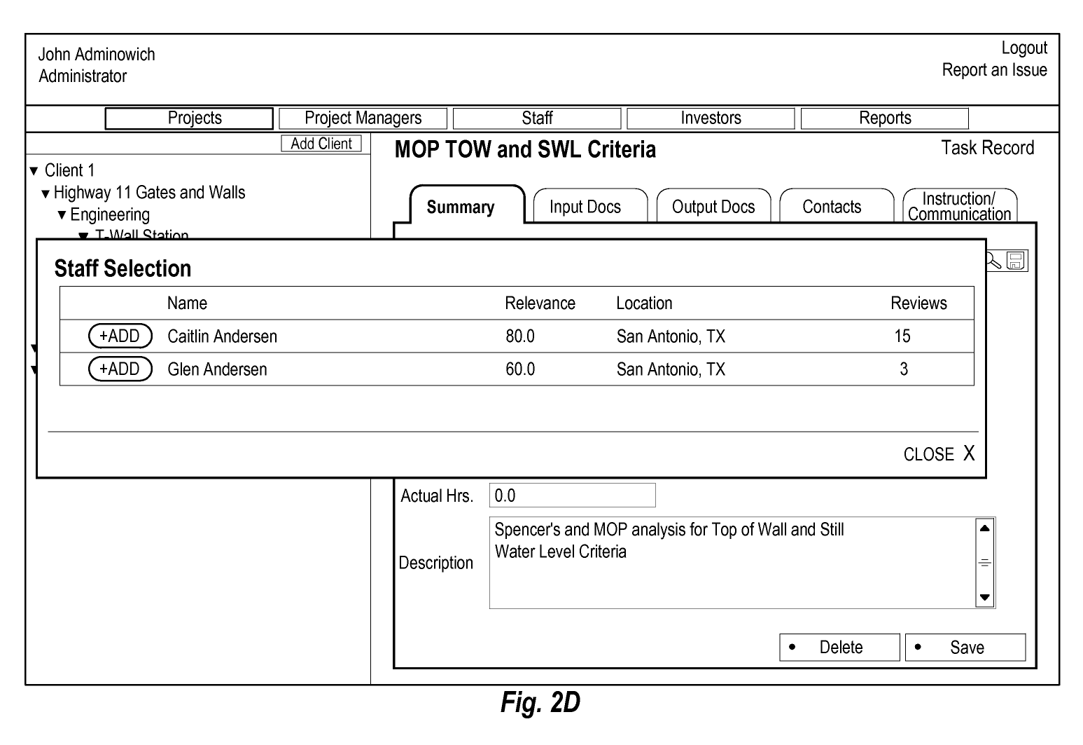

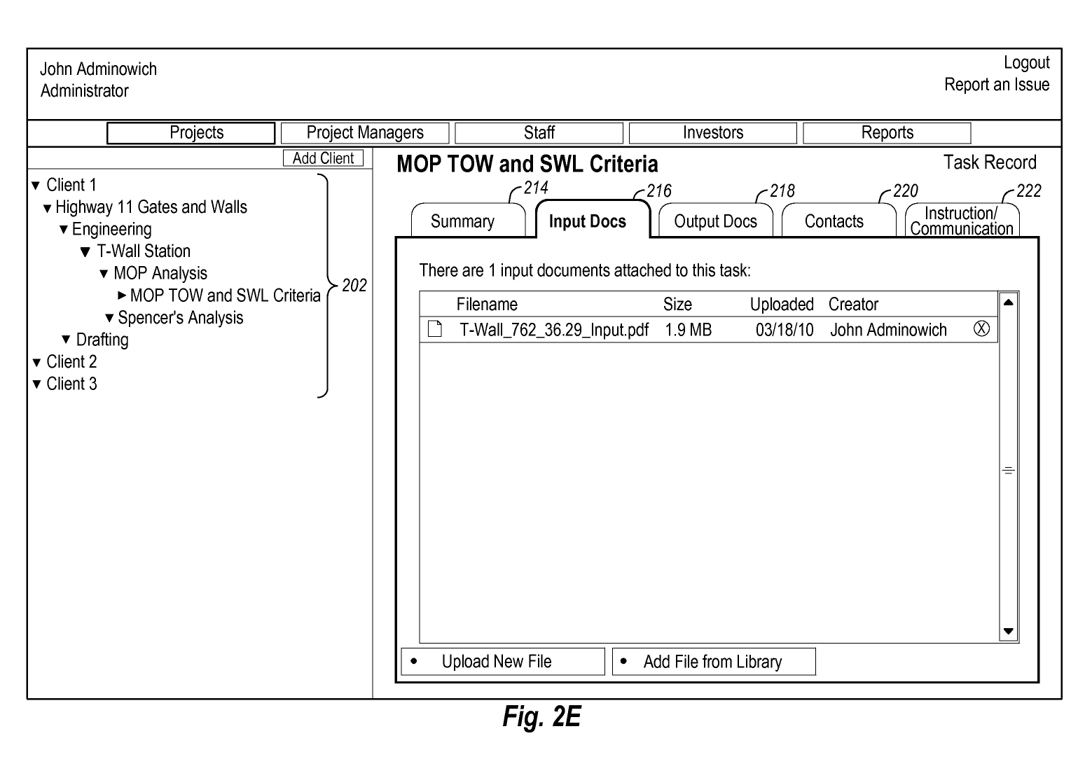

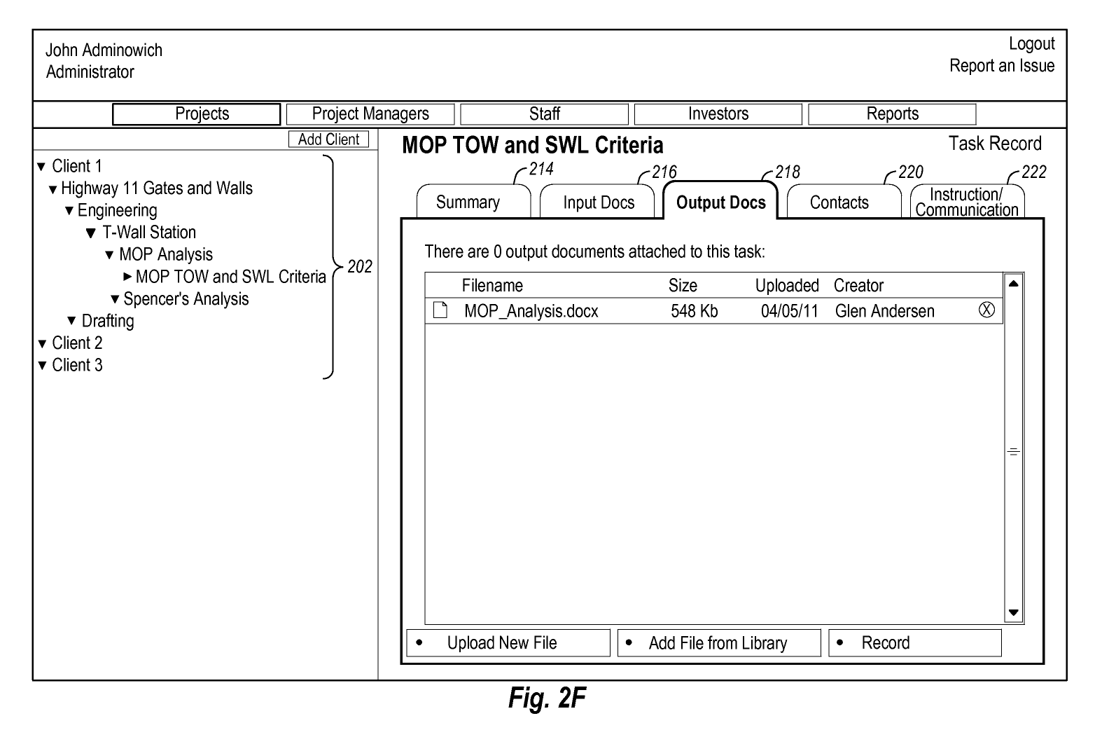

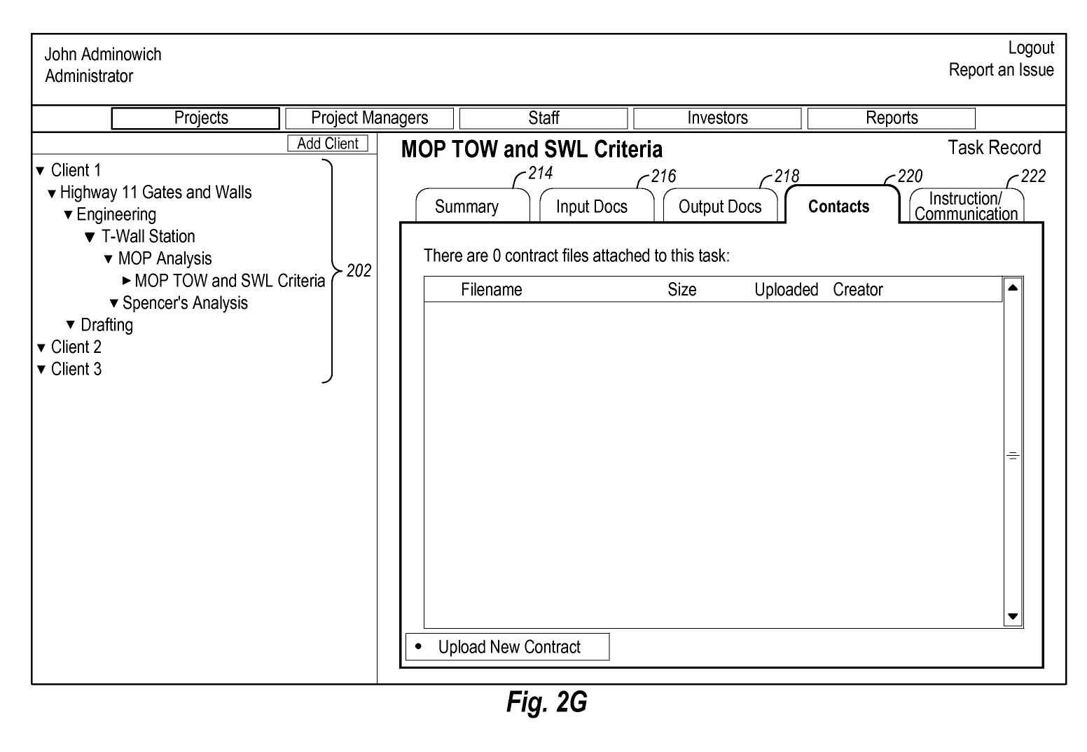

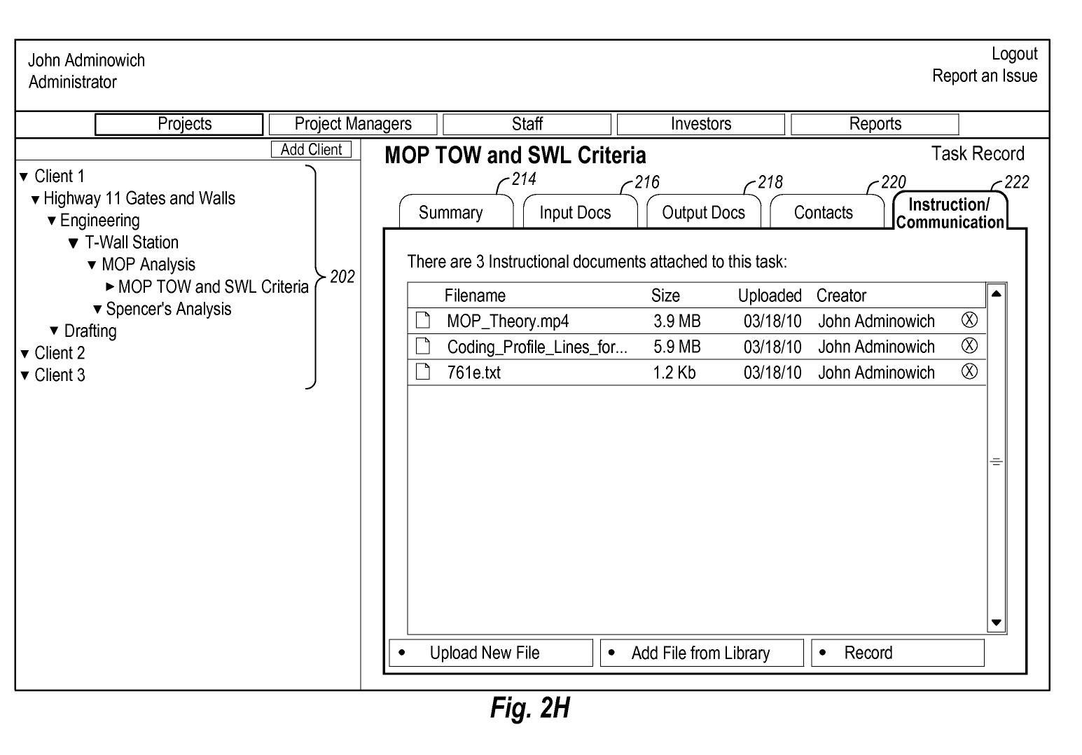

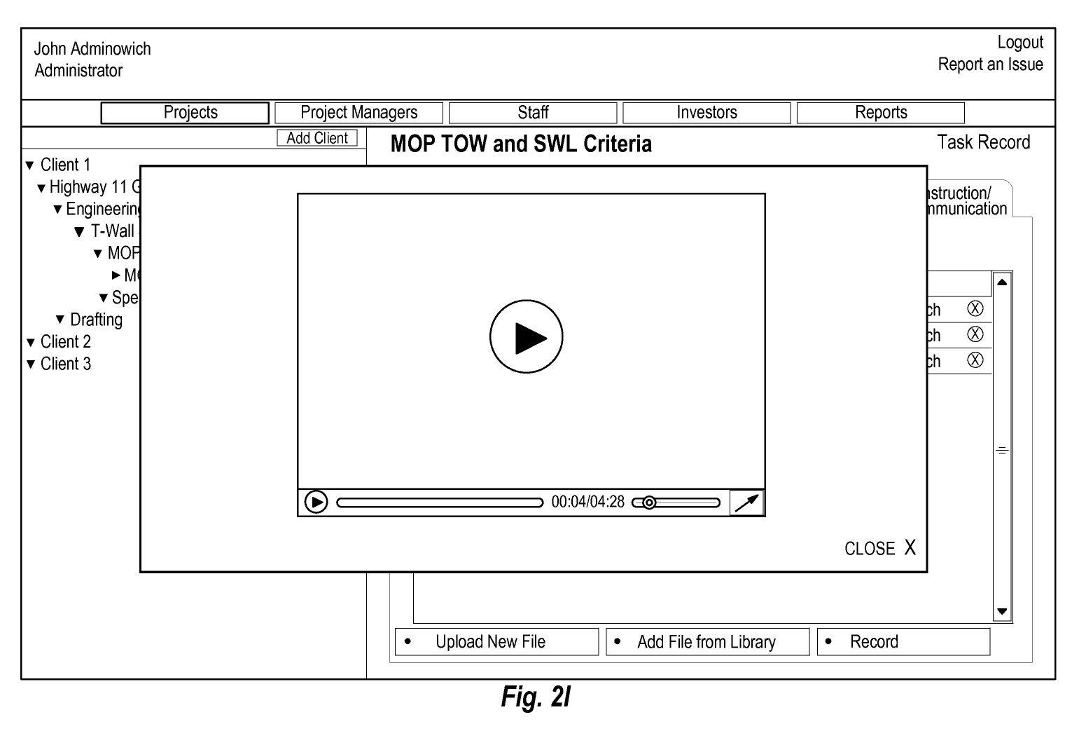

The functionally of each of these components will now be described more fully in the context of the user interfaces of FIGS. 2A-2I that are provided to clients 106 of a web-based communications platform, as provided by computer system 102.

Turning to FIG. 2A, illustrated is an administrative user interface, in accordance with one or more embodiments, for forming a work breakdown structure. The user interface of FIG. 2A can be generated by the user interface component 116 in connection with at least the work breakdown component 108. In this example, the user interface can include a work breakdown structure 202 that arranges work projects by client, with the client being at the topmost level. Each client can be associated with one or more work projects, which can each be sub-divided into a hierarchical arrangement of work assignments (e.g., categories and tasks). Work assignments can be further broken down using the work breakdown structure 202 into separate tree structures, or into the same tree structure. Accordingly, portions of a project can be assigned to other project managers who can then design and assign work assignments to other staff. Each level of the work breakdown structure 202 (e.g., a work category record) can be associated with metadata, including one or more of a name, an identification code, a price, or a description. Thus, the user interface can include a plurality of fields, such as name field 204, a code field 206, a price field 210, and/or a description field 212 for populating these values. All or part of any work breakdown structure can be reused to build new projects. The user interface can thereby include controls 208 for searching for similar work breakdown structures (using code field 206, for example) and for saving the current level and the entire structure below it. Note that the lump sum values of all work assignments in the work breakdown structure below a particular node can summed and carried up to that node (using price field 210, for example).

As shown, for instance, an administrative user, John Adminowich, is using a “Projects” portion of the administrative user interface of FIG. 2A to manage a work breakdown structure 202 that includes subsidiary structures for three different clients. The work breakdown structure for “Client 1” is shown as expanded, while the work breakdown structures for “Client 2” and “Client 3” are shown as collapsed. “Client 1” has one work project, “Highway 11 Gates and Walls,” which has been divided into six hierarchical levels, each of which can be assigned to work assignments. John Adminowich is using the user interface to view/edit a higher-level work assignment (or category), “T-Wall Station,” which includes lower-level work assignments (or tasks), including a “MOP Analysis” and a “Spencer's Analysis.” The price for these subsidiary assignments has been summed in data field 210 to indicate the total cost of the “T-Wall Station” to be $1500.

FIGS. 2B-2I illustrate additional administrative user interfaces, in accordance with one or more embodiments, for defining work assignments (or task records). These user interfaces enable managers to define, assign, and transmit work assignment electronically, along with relevant materials in various file formats. The user interfaces of FIGS. 2B-2I can be generated by the user interface component 116 in connection with at least the work assignment component 110. In this example, the user interfaces can include the work breakdown structure 202, as well as a plurality of work assignment tabs or workflows, including a summary tab 214, an input documents tab 216, an output documents tab 218, a contracts tab 220, and an instruction/communication tab 222.

Referring to FIG. 2B, the summary tab 214 or workflow can be configured to enable a manager define and assign a particular work assignment (or task) to a staff member or a sub-manager. Similar to the work category records described above, each task record can be associated with basic metadata, including a task name, a price, a description, a due date, etc., and the user interface can be configured to include corresponding fields (e.g., name field 224, price field 244, description field 252, due date field 240) for populating these values. The due date field 240 can be used in the selection of available staff, and for sending out electronic reminders and notifications. In addition, the summary tab 214 can be configured to include a plurality of other fields, controls, and links for managing other information about the subject work assignment or task.

A code field 226, for example, may be configured to enable the input of identification codes related to the specific nature of the work contained. A related control 228 can be configured to enable a manager to look up existing code(s) for re-use, or to save the entered code(s) for later use. The values in code field 226 can correspond to values used in code field 206 as part of work category records, and/or may comprise different values. The codes can represent the general nature of the work assigned. As such, one or more embodiments provide a marketing environment that enables the insertion of targeted marketing links at relevant points in the workflow. Because the codes represent the general nature of the work assigned, marketers can prepare a marketing approach for specific types of work assignments. Thus, the communications platform creates a rich platform for context-sensitive high-precision marketing for developers of business productivity software and for purveyors of reference information used for business, such as technical journals, technical books, or any other tool that is relevant to the specific work assignment. For example, marketing links may be inserted, based on values of code field 226, at the time that a work assignment is given and the staff has the need for productivity tools, background review information, or other tools. This can enable the staff to acquire relevant tools and/or background review information in real time in the same web-based environment from which the assignment is given.

A skills field 230 can be configured to enable the entry or selection of skills required or requested of staff members who will complete the work assignment or task. Turning briefly to FIG. 2C, for example, illustrated is a skills selection dialogue, in accordance with one or more embodiments, for selecting skills associated with the subject work project. The skills selection dialogue can configured to display available skill sets in a first pane, and to enable selection of one or more skill sets in a second pane. The available skill sets can be populated from a skills library that arranges available skills by discipline and according to types of work assignments (e.g., as associated with the codes of fields 206 and/or 226). The skills selection dialogue can also provide for the addition of new skill types beyond those already defined in the skills library. In some embodiments, skill sets can be developed according to patterns by discipline or other criteria (such as job type). Skill sets can be setup by an overall administrator of a group with common work types so that they can be standardized for use between organizations.

Returning to FIG. 2B, a staff selection control 232 can be configured to enable the intelligent selection of one or more staff to perform the work assignment. Upon selection of staff selection control 232, for example, a staff selection dialogue, such as the one illustrated in FIG. 2D, can be provided for the knowledgeable selection of staff for the assignment. The staff selection dialogue can be configured to intelligently list available staff, based on use of one or more of an “experiential matrix” or an “availability matrix.” As shown, using the experiential matrix and the availability matrix, the staff selection dialogue can list available staff, their relevance to the project, their physical location, and any manager or peer reviews. Relevance scores can be determined by requesting a rating from the project manager of each staff when each work assignment is completed correctly. These scores are then weighted with prior scores for a particular skill set or group of skill sets.

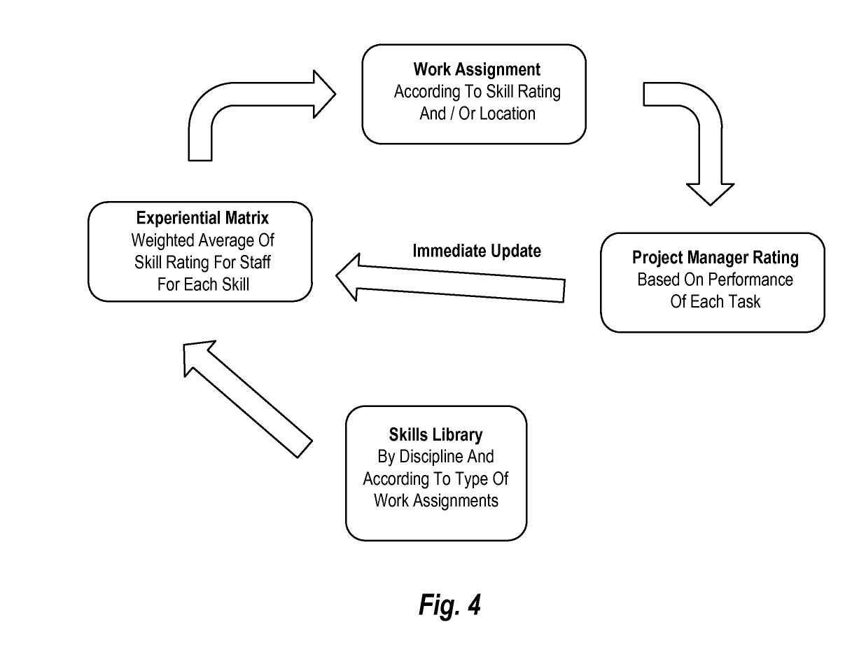

FIG. 4 illustrates an exemplary workflow of an experiential matrix. The experiential matrix can contain performance ratings for staff as they relate to specifically-defined skill sets. In some embodiments, the experiential matrix can also contain information related to the physical proximity of the staff to the project. As shown, the experiential matrix can contain a moving and dynamic average of skill ratings of staff members for each skill. The experiential matrix can be populated, at least in part, by the skills library described above. Using the experiential matrix, managers can make work assignments based on the staff's past skill ratings and/or location. The experiential matrix can then be updated upon further rating of the staff's performance by the project manager at the completion of the work assignment. Initial ratings for a new staff member that has not previously completed work through the web-based communications platform can be assigned during the staff set up process.

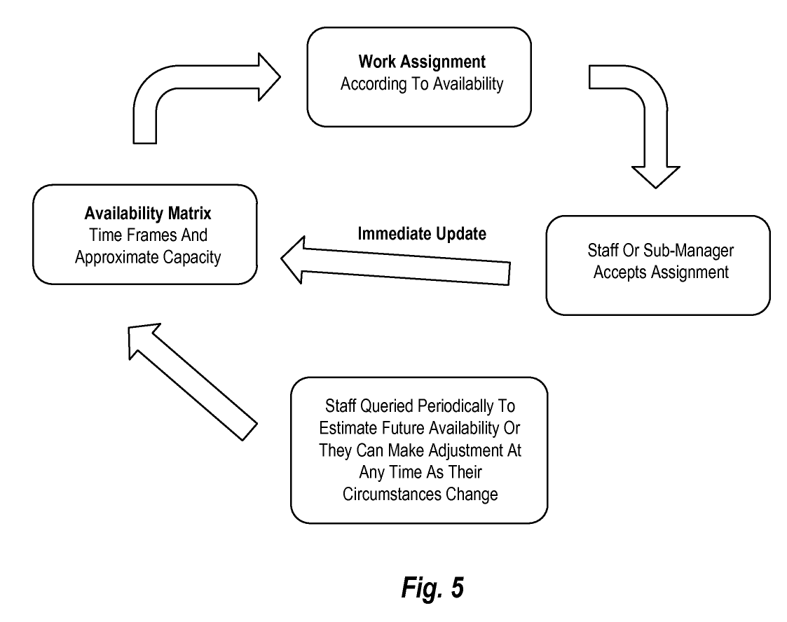

FIG. 5 illustrates an exemplary workflow of an availability matrix. Working in conjunction with the experiential matrix, the availability matrix provides for the selection of staff based upon estimated availability. Once a set of potential staff is identified based upon past performance and/or proximity to the project using the experiential matrix, the availability matrix provides information about the amount of time that each staff has available during the proposed duration of the assignment. Staff members can be queried periodically to estimate time available during specific time intervals and can also be permitted to adjust these estimates at any time if their circumstances change. When as assignment is accepted, the availability matrix for that particular staff can be immediately updated.

Returning again to FIG. 2B, the summary tab 214 can also include a status field 234 configured to display and/or change the current status of the work project. Possible statuses may include new, unassigned, assigned, declined, in progress, not required, overdue, complete, rework, PM takeover, reassigned, approved, payment authorized, or paid, among others. The summary tab 214 can also include a project manager contact link 236 configured to initiate an electronic message to the assigned project manager, and a project manager hours field 238 configured to track time spent by the project manager if it is necessary to take over the work assignment due to poor performance of the staff or for any other reason. An investor field 242 is configured to display or select any investor(s) associated with the project. Investors can fund the exchange of work assignments between different groups in different organizations. A client contact link 246 is configured to initiate an electronic communication with the client. An estimated hours field 248 and an actual hours field 250 can be provided for tracking the work project in terms of work assignments completed correctly on a lump sum basis, which is discussed in more detail later.

Referring now to FIG. 2E, the input documents tab 216 can be configured to enable a manager/administrator to provide any documents relevant to completion of the work assignment. The communications platform, through the input documents tab 216, can therefore provide for the transmission of input files, in any format, to any staff receiving the assignment. The input documents tab 216 can be configured to show all uploaded files, and to give the project manager the option of uploading files from their local computer or from a previously developed library (stored at storage component 114, for example) for repeated or similar tasks. Those files that are uploaded from the local computer can be placed into the library for future use.

FIG. 2F illustrates an embodiment of an output documents tab 218, which can be configured to enable a staff member to provide any documents that constitute the “product” of the work assignment. Similar to the input documents tab 216, the output documents tab 218 can also be configured to give the staff member the option of uploading files from their local computer or from a library for repeated or similar tasks or to perform an audio-video or similar screen capture or recording with specific information and/or questions for the project manager.

FIG. 2G illustrates a contracts tab 220, which can be configured to provide electronic copies of any contracts related to the work project. Through the contracts tab 220, the communications platform can enable managers and administrators to check relevant contracts prior to making work assignments. In some embodiments, the communications platform can be configured to suggest, or even require, that administrators or managers verify the validity and acceptability of each contract prior to making a work assignment. Contracts can be placed into a library for future reference if they apply to multiple work assignments or projects.

FIG. 2H illustrates an instruction/communication tab 222, in accordance with one or more embodiments, which is configured to provide access to instructional materials and communications material. Through the instruction/communication tab 222, the communications platform can enable the development of a library of training, reference, and communications materials for specific work assignments. These materials can be associated with the identification codes that capture the general nature of the work assignment so that the materials can be associated with future work assignments. The materials can be comprise any appropriate electronic format, such as Portable Document Exchange (PDF) files, flash video mp4 files, and examples of the output on similar assignments. Project managers can have the option to upload files directly from a local computer and/or from a library. Those files uploaded directly from a local computer can be placed into the library for future reference during the initial uploading process.

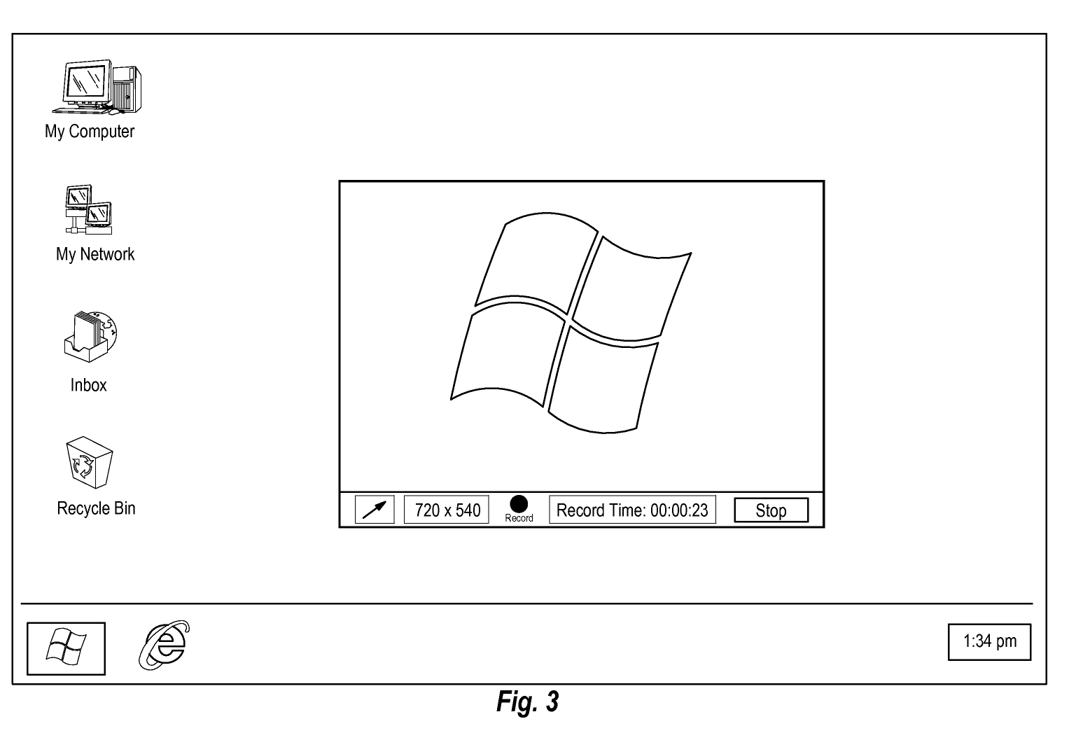

The communications platform can also be configured to include integrated tools that assist in the creation and consumption of any of the documents associated with work projects (e.g., input files, output files, instructional materials, etc.). For example, as illustrated in FIG. 2I, the communications platform can be configured to include an integrated video player (e.g., a flash video player) or similar device for consuming any files associated with a work project without leaving the user interface. In addition, as shown in FIG. 3, the web-based communications platform can be configured to include an integrated audio/video capture utility that can capture audio and/or video from the user's computer. Thus, the web-based communications platform can enable the creation of audio files, still images, and video files using combinations of the contents of a user's screen, images captured via a webcam or other camera, and/or audio captured via a microphone at the user's computer. Thus, for example, a manager creating a work project can record portions of his or her screen, potentially along with audio, as part of creating a work assignment. For instance, the manager can emphasize important areas in documents (by capturing a word processing application), the manager can train the staff about how to use a piece of software (by capturing the software), the manager can record audio instructions instead of typing them out, etc. The communications platform can be configured to include any other appropriate tools for enabling the creation and consumption of input documents, output documents, contracts, and instructional materials, such as an integrated web-based PDF viewer, an integrated web-based document editor, an integrated web-based image or video editor, and the like.

The library of training, reference, and communications materials can constitute a set of on-line materials for use in continuing education and/or professional development of staff. When creating a work assignment, embodiments enable a manager to assign relevant training materials to the work assignment, which are then made available to any assigned staff. The assigned staff can then review/complete the training materials in addition to completing the work assignment itself. When the assigned staff indicates that the work assignment is completed, the communications platform can provide the manager the identity of any training materials the staff completed. Embodiments provide for the issuance of a certificate of completion for Professional Development Hours or Continuing Education to staff after satisfactorily completing a work assignment involving a new skill set.

Together the administrative user interfaces FIGS. 2B-2I can be used to manage work assignments in terms of work assignments completed correctly on a lump sum basis and acceptance of a correctly completed work assignment by a manager. Using the administrative user interfaces, a manager can define how to “correctly” complete a work assignment by providing a “definition of success” that can include one or more of: 1) a statement of work that defines how the work assignment is completed correctly, 2) exemplary previously completed assignments having similar scope, or 3) instructional and/or reference materials that contain specific instructions regarding work process and formatting of output. These documents can be provided using the input documents tab 216 and/or the instruction/communication tab 222, for example. The manager can further define a lump sum payment for completing the work assignment (using price field 244) and estimated hours for completion (using estimated hours field 248).

Managing work assignments in terms of work assignments completed correctly on a lump sum basis through the communications platform can help to control schedule. For instance, schedule can be controlled by one or more of: 1) establishing due dates at the time when work assignments are assigned and accepted (using due date field 240), 2) sending email notifications of pending due dates, 3) permitting managers to “take over” a work assignment and either work it personally or reassign it to another staff with the potential of partial or complete loss of revenue by the originally-assigned staff, or 4) providing for the motivation of staff through lump sum payments for work assignments so that assigned staff are personally responsible for efficiency, productivity, and correctness. Schedule can also be controlled by permitting staff to accept or reject a work assignment after reviewing the scope of the assignment, the definition of success, and the lump sum payment amount. Hence, by accepting an assignment, the staff agrees to the schedule, the scope, the definition of success and the lump sum payment amount.

Managing work assignments in terms of work assignments completed correctly on a lump sum basis through the communications platform can also help to control cost. Cost can be controlled by one or more of: 1) associating a lump sum value with each work assignment regardless of the amount of time actually required by the staff to complete the assignment or 2) permitting the manager to deduct costs directly from the lump sum in order to complete the task personally or through other staff if necessary to meet the schedule. Permitting the staff to accept or reject assignments (as previously discussed) also helps to control cost. In some embodiments, the lump sum amount might reflect the value of a particular work assignment to the overall project and/or might be related to the salary of the staff or to some type of bonus or incentive system.

In some embodiments, the communications platform can be installed locally by an organization, and the local installation can communicate with other installations. As such, some embodiments provide for delivering work assignments outside of a local group and/or organization by permitting remote logins to an organization's local installation of the communications platform by authorized individuals in order to make and/or receive assignments. These external support personnel can be offered up by their own local installation administrators and can be identified by external managers through a global installation that is accessible by all local installations.

In one or more embodiments, the communications platform is also configured to archive work assignments and any related files, including input, output, and training/reference materials, along with the work breakdown structure. These files can be kept in a “live” data base (at storage component 114, for example) until they can be transferred to an “offline” archive. The communications platform can also be configured to perform version control and tracking of files associated with work assignments.

The user interfaces can be configured to include differing functionality for differing user types. For instance, FIGS. 2A-2I illustrate user interfaces presented to an administrative user, which can include functionally related to Projects, Project Managers, Staff, Investors, and Reports. The user interfaces can be configured such that each user can view only that portion of an installation that is directly related to his or her role. For example, administrators may see the entire installation, where they can enter user information, assign logins and passwords, manage the use of codes, verify that contracts are in place for work projects, etc. Project managers may be permitted to develop a work breakdown structure for work projects; to identify specific work assignments; to input relevant data; to develop instruction, training, and reference materials; to review staff rankings; to make and accept assignments; to review and approve completed assignments; etc. Auditors may see only their projects for review, while staff may see only the projects for which they have been given work assignments, and investors may see only those work assignments to which they have been invited to invest. In some embodiments, each user can see the full work breakdown structure associated with his/her particular assignments.

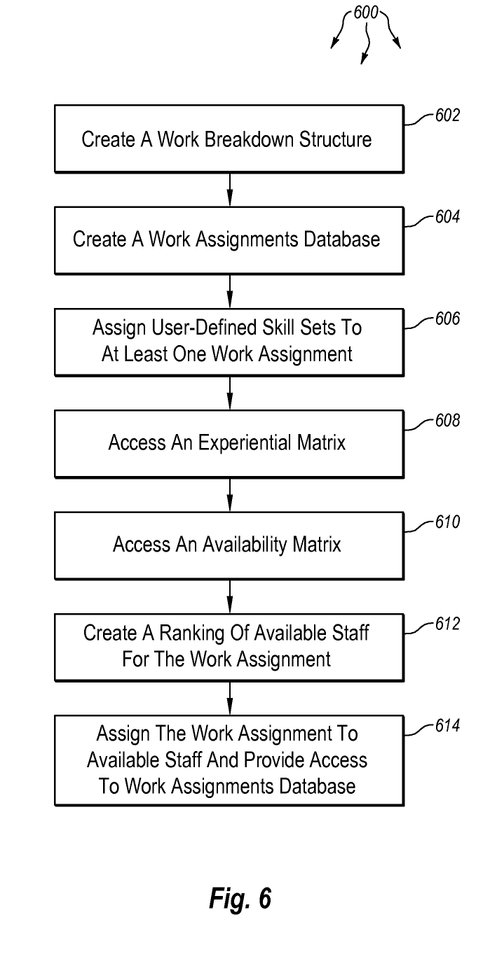

FIG. 6 illustrates a flow chart of an example method 600 for managing work assignments through a self-contained web-based communications platform. Method 600 will be described with respect to the components of computer architecture 100 and the user interfaces of FIGS. 2A-2I.

Method 600 includes an act of creating a work breakdown structure (act 602). Act 602 can comprise creating a work breakdown structure that breaks one or more work projects into a plurality of work assignments arranged within a plurality of user-defined hierarchical levels. For example, the work breakdown component 108 can be used, in connection with a user interface (e.g., the user interface of FIG. 2A) generated by user interface component 116, to break a work project into work assignments, including one or more categories or tasks. Act 602 can be performed automatically or in connection with user input. The work breakdown structure can be patterned after similar structures, or can be used in forming additional work breakdown structures for additional assignments. For example, work breakdown structures can be associated with one another on the basis of identification codes (e.g., alpha-numeric codes) associated with each level, the codes being usable to replicate the structures below the corresponding level.

Method 600 also includes an act of creating a work assignments database (act 604). Act 604 can comprise creating a work assignments database that stores one or more objects relevant to completion of at least one of the plurality of work assignments. For example, work assignment component 110 can create a work assignments database in storage component 114 that stores input documents, output documents, contracts, and instructional/communications documents that are uploaded by users (managers, staff, etc.).

Method 600 also includes an act of assigning user-defined skill sets to at least one work assignment (act 606). Act 606 can comprise assigning user-defined skill sets that capture one or more skills relevant to completing the at least one work assignment and permitting the matching of the at least one work assignment with staff having the one or more relevant skills. For example, work assignment component 110 can be used, in connection with a user interface (e.g., the user interface of FIG. 2C) generated by user interface component 116, to assign skill sets to the work assignment from a library. Act 608 can be performed automatically or in connection with user input.

Method 600 also includes an act of accessing an experiential matrix (act 608). Act 608 can comprise accessing an experiential matrix that maps the staff with performance ratings for previous work assignments and any user-defined skill sets associated with the previous work assignments. For example, work assignment component 110 can access an experiential matrix stored in storage component 114. The experiential matrix can dynamically update staff ratings as shown in FIG. 4, and additionally track proximity information.

Method 600 also includes an act accessing an availability matrix (act 610). Act 610 can comprise accessing an availability matrix that contains temporal information about staff availability. For example, work assignment component 110 can access an availability matrix stored in storage component 114. The availability matrix can track staff availability as shown in FIG. 5.

Method 600 also includes an act of creating a ranking of available staff for the work assignment (act 612). Act 612 can comprise creating a ranking of available staff for the at least one work assignment based on the user-defined skill sets for the at least one work assignment, the experiential matrix, and the availability matrix. For example, work assignment component 110 can create a ranking of available staff based on an experiential matrix and an availability matrix stored in storage component 114. The staff rankings can be presented (e.g., by user interface component 116) to a manager for selection of available staff using a user interface similar to the one illustrated in FIG. 2D.

Method 600 also includes an act of assigning the work assignment to available staff and providing access to the work assignments database (act 614). Act 614 can comprise assigning the at least one work assignment to a particular one or more of the available staff, and providing at least access to the work assignments database, including the one or more objects relevant to completion of at least one of the plurality of work assignments, to the particular one or more of the staff. For example, responsive to user input selecting available staff from the user interface of FIG. 2D, the work assignment component 110 can assign the selected staff member to the work assignment and provide the selected staff access to the work assignments database.

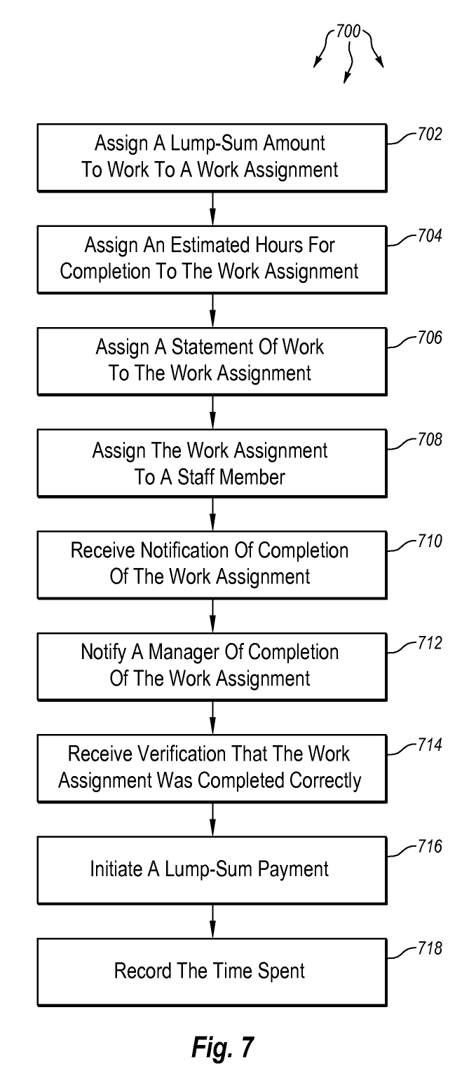

FIG. 7 illustrates a flow chart of an example method 700 for managing work assignments that are evaluated based on work assignments being completed correctly and on estimated hours for completion of the work assignments. Method 700 will be described with respect to the components of computer architecture 100 and the user interfaces of FIGS. 2A-2I.

Method 700 includes an act of assigning a lump-sum amount to a work assignment (act 702). Act 702 can comprise assigning a work assignment a lump-sum amount that is credited when the work assignment is completed correctly. For example, work assignment component 110 can assign a work assignment a lump sum amount for correct completion of the work assignment based on user input, such as user input at price field 244 in the user interface of FIG. 2B.

Method 700 also includes an act of assigning an estimated hours for completion to the work assignment (act 704). Act 704 can comprise assigning to the work assignment an estimated hours for completion of the work assignment. For example, work assignment component 110 can assign a work assignment an estimated hours for completion based on user input, such as user input at estimated hours field 248 in the user interface of FIG. 2B.

Method 700 also includes an act of assigning a statement of work to the work assignment (act 706). Act 706 can comprise assigning to the work assignment a statement of work that defines how the work assignment is completed correctly. For example, work assignment component 110 can assign a statement of work to the work assignment via an uploaded file provided using an input documents tab 216 of a user interface, such as the user interface shown in FIG. 2E.

Method 700 also includes an act of assigning the work assignment to a staff member (act 708). For example, using an experiential matrix and an availability matrix stored in storage component 114, the work assignment component 110 can assign the work assignment to a particular staff member that is available and skilled for performing the work assignment. For example, a staff member is assigned the work assignment by email, SMS, a user interface, etc., through a notification via the summary tab 214 of the user interface and the staff field 232 shown in FIG. 2B.

Method 700 also includes an act of receiving notification of completion of the work assignment (act 710). Act 710 can comprise receiving notification from the particular staff member that the work assignment has been completed, and a number of hours spent by the particular staff member to complete the work assignment. For example, work assignment component 110 can receive, via email, a user interface, etc., a notification from the particular staff that the work assignment is completed, along with hours spent by the particular staff competing the work assignment.

Method 700 also includes an act of notifying a manager of completion of the work assignment (act 712). Act 712 can comprise, notifying a manager that the work assignment has been completed subsequent to receiving notification from the staff member. For example, the work assignment component 110 can notify an assigned manager that the particular staff completed the work assignment via an email notification, an SMS notification, a notification via a user interface generated by user interface component 116 (e.g., in note areas), and the like.

Method 700 also includes an act of receiving verification that the work assignment was completed correctly (act 714). Act 714 can comprise receiving verification from the manager after a review of the work assignment that the work assignment was completed correctly. For example, the work assignment component 110 can receive, via a user interface generated by user interface component 116, verification from a manager that the particular staff completed the work assignment in accordance with the statement of work. The status field 234 of summary tab 214 is an example of such an interface for notification capability via email, SMS or similar.

Method 700 also includes an act of initiating a lump-sum payment (act 716). Act 716 can comprise initiating payment of the lump-sum amount to the particular staff member as a direct payment, a credit against a salary, or a credit against a bonus or incentive program. For example, work assignment component 110 can credit money to the particular staff as defined in price field 244, affect the particular staff's salary in some way, or credit the staff with points related to a bonus or initiative system.

Method 700 also includes an act of recording the time spent (act 718). Act 718 can comprise recording the time spent by the particular staff member to complete the work assignment. For example, work assignment component 110 can record in storage component 114 the number of hours spent by the particular staff to complete the work assignment. This information can be used by a manager for project tracking purposes, for performance review purposes, or for any other appropriate or similar purpose.

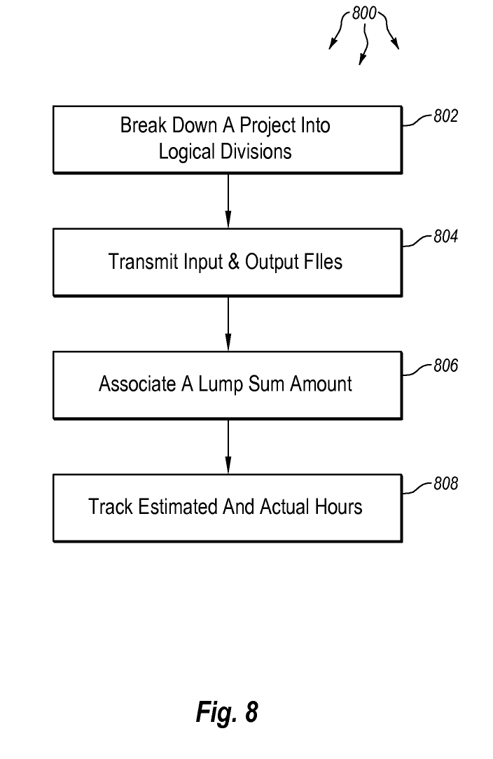

FIG. 8 illustrates a flow chart of an example method 800 for managing work assignments through a self-contained web-based communications platform. Method 800 will be described with respect to the components of computer architecture 100 and the user interfaces of FIGS. 2A-2I.

Method 800 includes an act of breaking down a project into logical divisions (act 802). Act 802 can comprise breaking down a project into logical divisions from which one or more work assignments are organized and referenced. For example, work breakdown component 108 can, with the assistance of user input, break a project down into a hierarchical arrangement of divisions, as in FIG. 2A. Each division can be associated with one or more work assignments that can be assigned to staff for completion

Method 800 also includes an act of transmitting input and output files (act 804). Act 804 can comprise transmitting input files and output files between a manager making a particular work assignment and a staff member performing the particular work assignment. For example, work assignment component 110 can create an assignments database in storage component 114 for storing input files, output files, contracts, and instructional/communications files. These files can be transmitted between managers and users using user interfaces generated by user interface component 116.

Method 800 also includes an act of associating a lump sum amount (act 806). Act 806 can comprise associating a lump sum amount to the particular work assignment, which is paid to the staff member when the particular work assignment is completed correctly, as determined by the manager. For example, a manager can use a user interface, such as the user interface of FIG. 2B, to assign a work assignment a lump sum amount for correct completion. Work assignment component 110 can then track the work assignment in terms of work assignments complete correctly on a lump sum basis. The lump sum amount can be paid to the staff member directly, or be measured against the staff member's salary or hourly wage, or bonusing or incentives program.

Method 800 also includes an act of tracking estimated and actual hours (act 806). Act 806 can comprise tracking estimated and actual hours worked by the staff member in completing the particular work assignment. For example, work assignment component 110 can use summary tab 214 and fields 248 and 250 to record and track estimated and actual hours that are then stored in storage component 114.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer-implemented method for managing work assignments through a self-contained web-based communications platform, the method comprising:
an act of a computer system, which includes one or more processors, creating a Work Breakdown Structure (WBS), the WBS breaking one or more work projects into a plurality of work assignments arranged within a plurality of user-defined hierarchical levels;
an act of the computer system creating a work assignments database that stores one or more objects relevant to completion of at least one of the plurality of work assignments;
an act of the computer system assigning one or more user-defined skill sets to the at least one work assignment, the user-defined skill sets capturing one or more skills relevant to completing the at least one work assignment and permitting the matching of the at least one work assignment with staff having the one or more relevant skills;
an act of the computer system accessing an experiential matrix that maps the staff with performance ratings for previous work assignments and any user-defined skill sets associated with the previous work assignments;
an act of the computer system accessing an availability matrix that contains temporal information about staff availability;
based on the user-defined skill sets for the at least one work assignment, the experiential matrix, and the availability matrix, an act of the computer system creating a ranking of available staff for the at least one work assignment; and
an act of the computer system assigning the at least one work assignment to a particular one or more of the available staff, and providing at least access to the work assignments database, including the one or more objects relevant to completion of at least one of the plurality of work assignments, to the particular one or more of the staff.

2. The method of claim 1, wherein the WBS enables one or more additional work breakdown structures to be created for additional work assignments or projects based upon the structure of previous work assignments.

3. The method of claim 1, wherein the one or more objects stored in the work assignments database include one or more of: (i) one or more input files that provide input data used in completing the at least one work assignment, (ii) one or more output files that are generated during completion of the at least one work assignment, (iii) one or more contracts related to the at least one work assignment, or (iv) instructional training and/or reference materials that provide training or information, respectively, relevant to completing the at least one work assignment.

4. The method of claim 1, wherein the work assignments database references each of the one or more objects by a corresponding user-defined reference code, and wherein the work assignments database archives the one or more objects for reference in future work assignments.

5. The method of claim 1, further comprising:
an act of the computer system creating a library that can assign each level of the WBS with a user-defined identification code, each user-defined identification code usable to replicate the WBS below a corresponding level in the WBS for use in additional work projects.

6. The method of claim 5, wherein at least one user-defined identification code comprises an alpha-numeric identification code.

7. The method of claim 1, further comprising:
an act of the computer system creating one or more of: staff, project manager, or client databases, which store relevant contact information and which are used by the computing system when making work assignments.

8. The method of claim 1, wherein the experiential matrix is usable as a prioritization tool for managers in assigning staff based upon ratings of staff performance on previous work assignments and any user-defined skill sets associated with the previous work assignments, and wherein the experiential matrix is updated with each work assignment.

9. The method of claim 1, wherein the availability matrix is updated through direct query to the staff for estimated available hours over various time frames, and wherein the availability matrix is updated automatically by the computer system when a work assignment is accepted.

10. The method of claim 1, wherein the availability matrix is usable to determine staff availability for a particular work assignment.

11. The method of claim 1, further comprising:
an act of the computer system creating one or more context-sensitive marketing links, which enable outside vendors to provide productivity tools and reference materials for specific work assignments at a point in time when the productivity tools and materials are needed and in the actual context of the work assignment.

12. The method of claim 1, wherein creating the ranking of available staff for the at least one work assignment is based further on staff proximity to the work project.

13. The method of claim 1, further comprising:
an act of the computer system creating an archive of previously-worked work assignments, along with any relevant information associated with the previously-worked work assignments.

14. The method of claim 1, further comprising:
an act of the computer system updating a status for the at least one work assignment as the at least one work assignment is completed.

15. The method of claim 1, further comprising:
an act of the computer system providing one or more of: an audio recorder, a video screen recorder, a camera or other input device, or a video player for use in developing and presenting instruction, training, or reference materials directly relevant to the plurality of work assignments and for the use of the staff to ask specific questions or seek clarification on work assignments or to describe specific details or present general information about the nature of their results.

16. The method of claim 1, wherein the computer system provides users the ability to function as one or more of the following:
an administrator, to enter user information, to assign logins and passwords, to manage the use of reference codes, and to verify that contracts are in place for a given work project;
project manager, to develop a WBS for a particular work project; to identify specific work assignments; to input relevant data; to develop instruction, training, and reference materials; to review rankings of staff based upon prior performance; to make and accept assignments; and to review and accept as complete assignments from staff members;
a staff member, to receive and work on work assignments, to view training and review videos, and to create audio or video screen recordings or recordings from other input devices with specific information or questions for the managers;
an investor, to fund work assignment transactions between multiple organizations; or
an auditor, to review completed work assignments for compliance with quality standards.

17. A computer-implemented method for managing work assignments that are evaluated based on work assignments being completed correctly and on estimated hours for completion of the work assignments, the method comprising:
an act of a computer system, which includes one or more processors, assigning a work assignment a lump-sum amount that is credited when the work assignment is completed correctly;
an act of the computer system assigning to the work assignment an estimated hours for completion of the work assignment;
an act of the computer system assigning to the work assignment a statement of work that defines how the work assignment is completed correctly;
an act of the computer system assigning the work assignment to a particular staff member;
an act of the computer system receiving notification from the particular staff member that the work assignment has been completed, and a number of hours spent by the particular staff member to complete the work assignment;
subsequent to receiving notification from the staff member, an act of the computer system notifying a manager that the work assignment has been completed;
an act of the computer system receiving verification from the manager that the work assignment was completed correctly;
an act of the computer system initiating payment of the lump-sum amount to the particular staff member; and
an act of the computer system recording the time spent by the particular staff member to complete the work assignment.

18. The method of claim 17, wherein the lump-sum amount relates to one or more of: a value of the work assignment to an overall work project, a salary of the particular staff member, or a bonus and/or incentive system.

19. The method of claim 17, further comprising:
an act of the computer system providing the work assignment, including notice of the lump-sum amount, the estimated hours for completion to the work assignment, and the statement of work to a plurality of staff members for review; and
an act of the computer system receiving acceptance of the work assignment from the particular staff member.

20. A computer-implemented method for managing work assignments through a self-contained web-based communications platform, the method comprising:
an act of a computer system, which includes one or more processors, breaking down a project into logical divisions from which one or more work assignments are organized and referenced;
an act of the computer system transmitting input files and output files between a manager making a particular work assignment and a staff member performing the particular work assignment;
an act of the computer system associating a lump sum amount to the particular work assignment, which is paid to the staff member when the particular work assignment is completed correctly, as determined by the manager; and
an act of the computer system tracking estimated and actual hours worked by the staff member in completing the particular work assignment.

21. The method of claim 20, further comprising:
an act of the computer system facilitating communications between the manager and the staff member though one or more of: automated e-mail status notifications, written communications embedded within one or more note areas of the web-based communications platform, or audio-visual screen recordings using a screen recorder and video player, SMS or other text messaging, or audio/visual recordings from other electronic devices, that are included in the web-based communications platform.

22. The method of claim 20, further comprising:
an act of the computer system using one or more identification codes to classify work contained in the particular work assignment;
an act of the computer system making the one or more identification codes available to marketers for contextually marketing products and/or services for the particular work assignment at the precise time when the marketing products and/or services are relevant; and
an act of the computer system using the one or more codes to trigger placement of one or more marketing links, embedded in the web-based communications platform, identifying one or more of tools or reference materials that may be relevant to performing the particular work assignment.

23. The method of claim 20, further comprising:
an act of the computer system providing one or more of instruction, training, or reference materials to the staff member performing the particular work assignment; and
an act of the computer system assigning the staff member training credit or continuing professional development credit when the particular work assignment is completed correctly, as determined by the manager.

24. The method of claim 20, wherein associating a lump sum amount to the particular work assignment, which is paid to the staff member, comprises associating a lump sum amount that is measured against the staff member's salary or hourly wage, or bonusing or incentives program.
